(19) United States
(12) Patent Application Publication
(10) Pub. No.: US 2021/0186049 A1
(43) Pub. Date: Jun. 24, 2021

(54) DEVICE AND METHOD FOR PREPARING COOLED OR FROZEN PRODUCTS

(71) Applicant: NESTEC S.A., Vevey (CH)

(72) Inventors: Youcef Ait Bouziad, Echandens (CH); Francois Texier, Cognin (FR)

(21) Appl. No.: 16/080,706

(22) PCT Filed: Mar. 9, 2017
(86) PCT No.: PCT/EP2017/055528

§ 371 Date: Aug. 29, 2018

(30) Foreign Application Priority Data
Mar. 11, 2016 (EP) 16159808.1

(51) Int. Cl. A23G 9/12; A23G 9/22; A23G 9/46

(52) U.S. Cl. CPC A23G 9/12; A23G 9/46; A23G 9/224

(57) ABSTRACT

The invention relates to a device (10) for preparing a cooled or frozen and/or foamed product, comprising: a product inlet (20) through which a certain quantity of fluid at ambient temperature, optionally also with air, enters the device, at a certain flow rate, this flow rate depending on the type of product to be prepared by the device; a processing chamber (108) through which the fluid flows and where it is processed, the processing chamber (108) defining a volume for the flow of fluid; at least a processing element (100, 200; 300) rotatable within the processing chamber (108) and configured to mix and/or scrap and/or foam by Couette Flow effect the fluid flowing through it; a cooling element (60) providing a certain cooling power configured to cool at least partially the processing chamber (108) which is at least partially in contact with the fluid. The invention further refers to a method for preparing a cooled or frozen and/or foamed product using a device (10) as the one described, and also to the use of such a device (10) for preparing a cooled or frozen and/or foamed product.

### FIELD OF THE INVENTION

The present invention is directed to a device for preparing cooled or frozen confectionary, which can also be aerated, such as ice cream, whipped yogurt or the like. The device represents a compact and fast system able to provide high quality products departing from raw fluid entering the device at ambient temperature. The present invention further relates to a method for preparing such cooled or frozen products.

### BACKGROUND OF THE INVENTION

Currently, the majority of cooled confectionary or frozen confectionary such as ice cream consumption concerns products already prepared cooled or frozen and maintained in that state for a later consumption. When these products are intended for home consumption, some drawbacks arise, such as the need to transport the products at home rapidly in order to keep them at the cold or frozen state, the need to store them in a freezer and the limited number of flavors available considering standard freezer volume. Additionally, the texture of such product is rather hard and far from the freshly made confectionary.

Whether it is intended for home consumption or for using in a business, store or the like, a solution available today is the use of a cooled confectionary or ice cream machine to produce fresh confectionary products. Thereby, although the obtained texture of the resulting product is more satisfactory, the preparation procedure by means of the known machines has several drawbacks.

In particular, all the ingredients must be mixed previously, the volume of such machines corresponds usually to five or more serving portions of the same flavor and the time necessary is about half an hour (when talking of ice-cream for example). Moreover, the ingredients necessary for the preparation come in contact with a large number of parts of the preparation machine (e.g. a stirrer, tanks, or a dispenser), which all have to be cleaned. Other alternatives imply a preparation at ambient temperature before the cooling or freezing phase in a standard freezer. Hence, they are also time consuming and require cleaning tasks.

Moreover, these known machines are very voluminous and require long preparation times. Besides, more than one serving portion has to be prepared at a time (known as batch preparation). The known machines preparing cooled or frozen confectionary in batches therefore have several limitations, as discussed, such as the volume to be processed which needs to be prepared in advance and also limiting the end product to an homogeneous one where no layering distribution (by flavor, for example) is possible. Therefore, there is a demand for increasing the convenience of the preparation of cool or frozen confectionery, in particular, using machines and systems which are more compact, being able to produce mixtures of a high quality and highly aerated with stabilized foaming, providing single-serve portions and particularly avoiding the need of cleaning afterwards.

The present invention thus aims at providing a device able to address these needs and which overcomes the drawbacks in the state of the art, providing an in-line and on-demand system delivering ice-cream or cooled or foamed products departing from a fluid raw product at ambient temperature.

### SUMMARY OF THE INVENTION

According to a first aspect, the invention relates to a device for preparing a cooled or frozen and/or foamed product, comprising: a product inlet through which a certain quantity of fluid at ambient temperature, optionally also with air, enters the device, at a certain flow rate, this flow rate depending on the type of product to be prepared by the device; a processing chamber through which the fluid flows and where it is processed, the processing chamber defining a volume for the flow of fluid; at least a processing element rotatable within the processing chamber and configured to mix and/or scrap and/or foam by Couette Flow effect the fluid flowing through it; a cooling element providing a certain cooling power configured to cool at least partially the processing chamber which is at least partially in contact with the fluid.

The device processing element of the device, according to a first embodiment, typically comprises a single rotatable element: this single rotatable element comprises one or a plurality of disturbing means allowing foaming of the fluid in the processing chamber when the element rotates; the element further comprises one or a plurality of scraping means allowing scraping of the product from the walls of the processing chamber when the element rotates.

Preferably, the scraping means are mounted on elastic means allowing them to properly contact the inner walls of the processing chamber. Typically, the rotational speed of the processing element is calculated as a function of the type product to be prepared in the device and/or its foaming level.

According to a second embodiment, the processing element of the device comprises a foaming element and a distinct scraping element, both elements being rotatable in the processing chamber at the same or different speed and/or direction of rotation. The rotational speed and/or the direction of rotation of the foaming element and of the scraping element are calculated depending on the type of product to be prepared in the device and/or on its foaming level.

Typically, in the device of the invention, the flow rate of fluid into the processing chamber is calculated to allow that the cooling power provided by the cooling element cools the fluid to a desired temperature before the fluid leaves the processing chamber. Preferably, the rotational speed of the processing element is comprised in the range of 1 to 10 rpm to prepare a cooled or chilled product. The rotational speed of the processing element is typically comprised in the range of 1000 to 3000 rpm to prepare an ice-cream product or a foamed or aerated product. The processing chamber preferably connects the product inlet and a product outlet, so that the cooled or frozen and/or foamed product is delivered continuously.

The length of the processing chamber traversed by the fluid typically matches the cooling element, defining an inner refrigerating surface in contact with the fluid flow.

According to the invention, the processing element is preferably configured as a cylinder, rotating inside a cylindrical processing chamber, concentrically arranged within it and forming a gap of a thickness between them through which the fluid flows and is processed. The gap configured between the cylinders has a thickness (t) comprised between 0.1 mm and 10 mm.

Typically, according to the invention, the device is connectable to a container configured as a cartridge, as a capsule or the like, where a fluid at ambient temperature is stored to be provided in the device through the product inlet. Preferably, the container comprises identification means, the identification means comprising process parameters allowing the preparation of a cooled or frozen and/or foamed product in the said device. The process parameters are typically one or a combination of: type of product to be produced, temperature of the product delivered, flow rate of fluid in the processing chamber, rotational speed of the processing element, air ratio to incorporate in the processing chamber.

The device is typically configured to be arranged either horizontally or vertically when it is in operation.

According to a second aspect, the invention relates to a method for preparing a cooled or frozen and/or foamed product using a device as the one described, the method comprising:
delivering a fluid through the product inlet into the processing chamber of the device at a certain flow rate defined so as to provide the fluid with a certain residence time in the device, before it is delivered through a product outlet;
depending on the type of product to be made optionally adding air to the fluid delivered through the product inlet;
depending on the type of product to be made, rotating at a certain speed the processing element;
simultaneously to the rotation of the processing element, activating the cooling element to cool at least partly the processing chamber in contact with the fluid.

Preferably, the rotational speed and/or the direction of rotation of the processing element varies depending on the product to be prepared, from a low speed in the range of 1 to 10 rpm to prepare a cooled or chilled product to a high speed in the range of 1000 to 3000 rpm to prepare an ice-cream product or a foamed or aerated product.

In the method of the invention, air is typically introduced into the processing chamber when aerated product is desired.

According to another aspect, the invention refers to the use of a device as the one described for preparing a cooled or frozen and/or foamed product.

### BRIEF DESCRIPTION OF THE DRAWINGS

Further features, advantages and objects of the present invention will become apparent for a skilled person when reading the following detailed description of non-limiting embodiments of the present invention, when taken in conjunction with the appended drawings, in which:

FIG. 1 shows a transversal cut view of a device for preparing cooled or frozen confectionary according to a first embodiment of the present invention.

FIG. 2 shows a frontal transversal cut view of a device for preparing cooled or frozen confectionary according to a first embodiment of the present invention.

FIG. 3 shows the main components in a device for preparing cooled or frozen confectionary according to a first embodiment of the present invention.

FIG. 4 shows in more detail the main components in a device for preparing cooled or frozen confectionary according to a first embodiment of the present invention, as represented in FIG. 3.

FIGS. 5-6 show a general overview of a device for preparing cooled or frozen confectionary according to a first embodiment of the present invention, particularly showing where the refrigerant enters and exits the device.

FIG. 7 shows a transversal cut view of a device for preparing cooled or frozen confectionary according to a second embodiment of the present invention.

FIG. 8 shows a frontal transversal cut view of a device for preparing cooled or frozen confectionary according to a second embodiment of the present invention.

FIG. 9 shows the main components in a device for preparing cooled or frozen confectionary according to a second embodiment of the present invention.

FIGS. 10a-b show schematically the basic principle of couette flow for generating shear stress used in a device according to any of the first or second embodiments of the present invention.

FIG. 11 shows the theoretical energy path scheme involved in the preparation of cooled confectionary using a device according to any of the first or second embodiments of the present invention.

FIG. 12 shows the theoretical energy path scheme involved in the preparation of frozen confectionary using a device according to any of the first or second embodiments of the present invention.

### DETAILED DESCRIPTION OF EXEMPLARY EMBODIMENTS

According to a first aspect, the invention relates to a device 10 for preparing a cooled or frozen product, which can also be aerated. The device 10 of the invention is provided with raw fluid product, typically liquid, at ambient temperature and optionally also with air, through a product inlet 20: from this fluid and also possibly air the final aerated or cooled or frozen product will be produced by means of the device 10. Typical products prepared by the device 10 are ice cream or whipped yogurt, for example. The device 10 works in-line providing whenever needed a portion of aerated or cooled or frozen product as desired, freshly prepared on demand departing from raw fluid at ambient temperature coming from the product inlet 20.

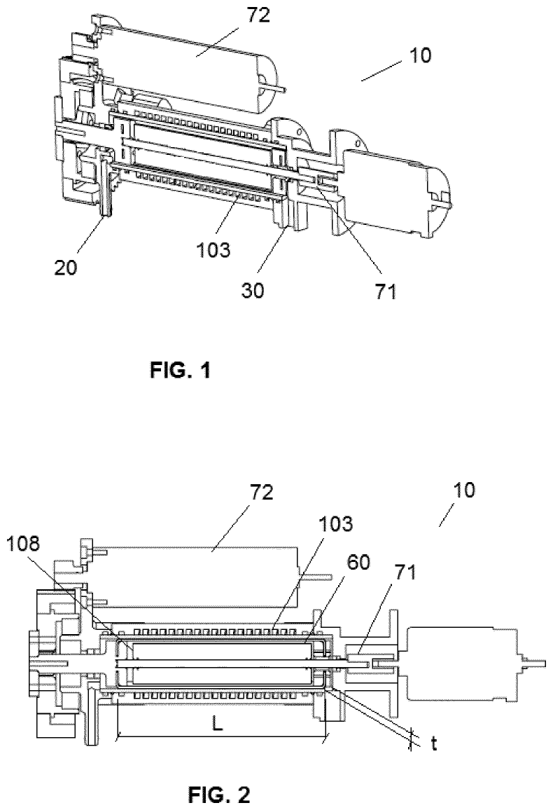

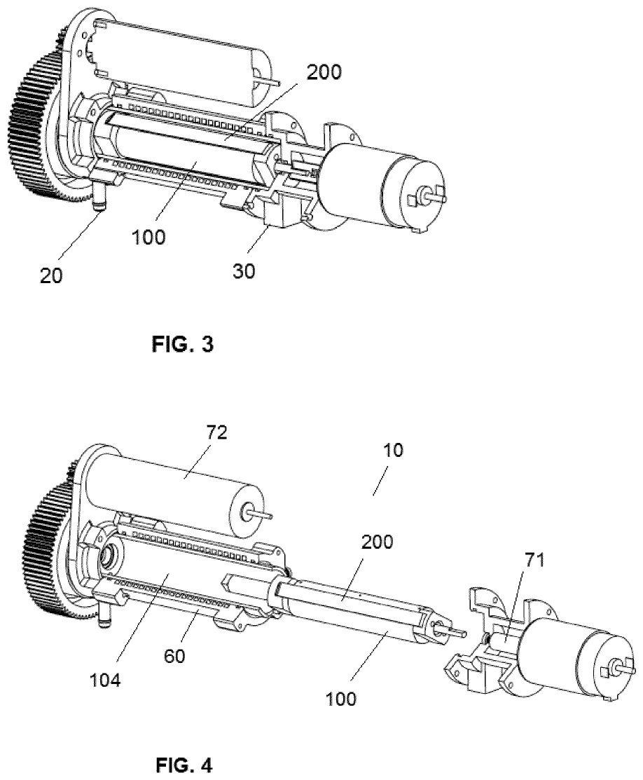

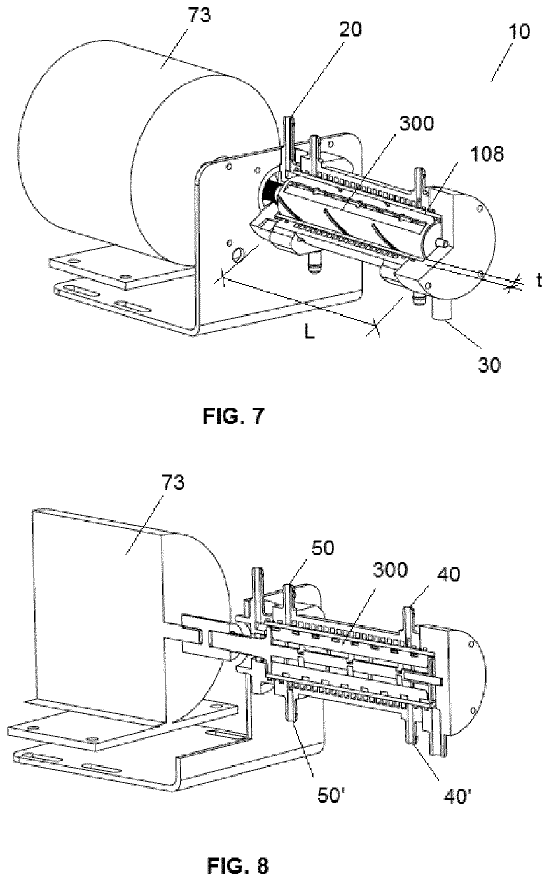

The device 10 comprises a foaming element 100 and a scraping element 200, which can either be configured in one single element (according to a second embodiment of the invention, as represented in FIGS. 7-9) or they can be configured in two different elements (according to a first embodiment of the invention, as represented in FIGS. 1-6).

Referring now to FIG. 1 or to FIG. 4, for example, the device 10 of the invention comprises a foaming element 100 and a separated scraping element 200. Typically, the foaming element 100 is configured as a cylinder, as shown in FIG. 4: foaming occurs thanks to a Couette Flow effect in the mixture of air and fluid entering the device 10, as it will be further explained in more detail. It is also possible and comprised within the scope of the present invention that no air is introduced through the product inlet 20 (thus, only fluid enters the device) when an outlet product having no foaming is desired. Even when not shown, the air entry (ratio of air provided with the fluid entering the device) can be controlled so the level of foaming can be further controlled by the device of the invention.

The product to be processed (entering the device 10 through the product inlet 20) flows through a processing chamber 108: this processing chamber is created delimited by the refrigerating surface 104 and by the external surface of the foaming element 100. By the circulation of the product through this processing chamber 108 (further under rotation of the foaming element 100 and of the scraping element 200) the product is refrigerated, processed and possibly also foamed when air is further introduced. The length L and the chamber thickness t of the processing chamber 108 actually determines the path followed by the product flowing in the device (in fact, it determines the flow rate and the residence time), from the time it enters the device at ambient temperature through the product inlet 20, until it exits the device through the product outlet 30, already prepared: the flow rate and the residence time influence on the temperature the product is delivered at the outlet and also on the foaming level of it; particularly, the thickness t of the processing chamber 108 and its length L (volume in the processing chamber 108) relate to the Couette Flow effect followed by the product (in particular to the shear stress to which the product is subjected) and this determines the foaming level of it.

The scraping element 200 is typically configured as represented in FIG. 4, comprising for example one or more (typically two) scrapers, preferably made in metal, typically in stainless steel, arranged around the external surface of the foaming element 100. The scraping element allows scraping the frozen product remaining attached to a refrigerating surface 104, so to prepare a homogeneous product mixture.

According to this first embodiment of the device of the invention, the foaming element 100 is rotated by a foaming motor 71, while the scraping element 200 is rotated by means of a separate scraping motor 72. The fact of having two different motors allows to independently control the rotational speed of each element, scraping and foaming element, 200 and 100, respectively, and also even to modify the direction of rotation of each of them in order to prepare different product mixtures, as desired, having higher foaming, for example, or the like.

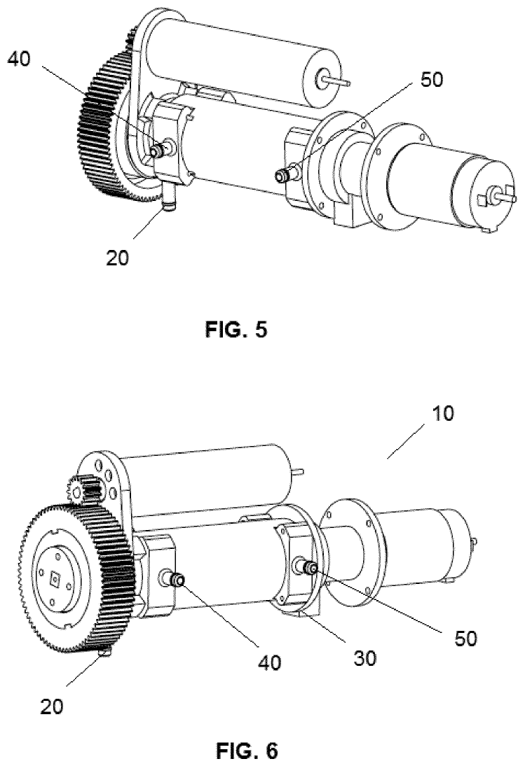

As represented in FIG. 4 for example, the device 10 of the invention further comprises an evaporator 60 (heat exchanger) comprising a refrigeration channel 103 through which a refrigerant fluid flows, typically in coil or serpentine configuration: the refrigerating surface 104 created cools down the product when it contacts the surface 104 during its travel from the product inlet 20 towards a product outlet 30, through which the prepared product is delivered. FIGS. 5 and 6 show preferred arrangements of the refrigerant inlet 40 and of the refrigerant outlet 50 in a device 10 according to a first embodiment of the invention, typically arranged at distant sides of the foaming element 100.

The fluid entering the device 10 through the product entry 20 can come from external containing means (not shown) or it can come for example from a capsule or confined container which is externally plugged to the device 10. In this last case (capsule-type container) external expelling means (not shown) typically a piston, will be preferably provided, these means being able to displace inside the volume of the container and expel from it its content.

Preferably, the chamber thickness t of the processing chamber 108 is comprised in the range of 0.1 mm to 10 mm. With these preferred values for the processing chamber thickness t, optimal foam properties can be achieved. For foaming to take place in the processing chamber 108, the device of the invention is based on the foaming energy being provided by high shear energy, which is achieved by passing a mixture of fluid and air coming through the product inlet 20 at least partly by Couette Flow through the processing chamber 108. It is important that the width or gap in the processing chamber 108 remains very small in order to produce high shear stress into the mixture allowing adequate foaming.

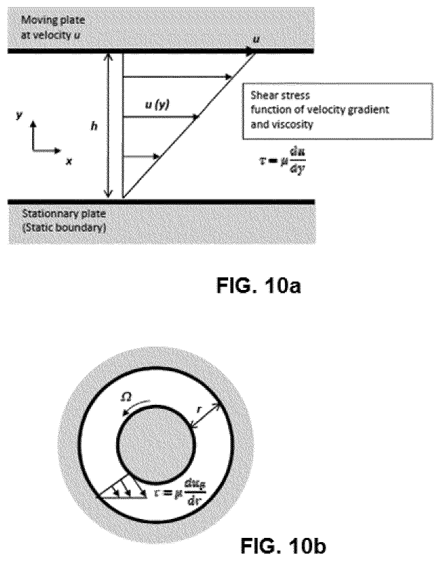

Couette flow refers to a laminar flow of a viscous fluid in a space between two parallel plates. The basic principle of Couette flow is shown in FIGS. 10a and 10b. In FIG. 10a a movable two-dimensional boundary plate moves with a certain velocity u in respect to a stationary two-dimensional boundary plate. In between the two boundary plates is present a fluid. The movement of the movable boundary plate causes the fluid to move. Two boundary conditions define the movement of the fluid. Directly at the stationary boundary plate, the fluid does not move at all, due to friction forces at the stationary boundary plate. Therefore, the velocity u is zero. Directly at the movable boundary plate, friction causes the fluid to move with the velocity u of the movable boundary plate.

In a simple model, the velocity u of the fluid increases linearly in a direction y measured from the stationary boundary plate. Thereby, a shear stress r is caused in the fluid, which depends on the distance between the two boundary plates, the viscosity of the fluid, and the absolute velocity of the moving boundary plate. The shear stress in the fluid results in a shear energy, which can be used as foaming energy, as used in the device of the present invention.

As discussed previously, the device of the invention is able to provide different types of final products, frozen or cooled, which can further be aerated or not. Typically, the products to be delivered are ice-cream, a cooled or chilled liquid and foamed liquid.

For the different products to be obtained, there are several input parameters to take into consideration:
Volume (length L and thickness t) of the processing chamber 108; these values are fixed in a device 10, influencing the cooling temperature of the product and the foaming level of the product;
Air being introduced or not together with the fluid entering the product inlet 20 and ratio of air introduced: this relates directly to foaming or not the product and, when foamed, to which level;
Rotational speed and direction of rotation of the foaming element 100 and of the scraping element 200, directly influencing the foaming level of the product and the type of product finally obtained;
Temperature of the refrigerant fluid introduced through the refrigerant inlet 40, which is something fixed in the device 10 of the invention;
Flow rate of the fluid (optionally with air) introduced through the product inlet 20: this is variable and depends on the product to be prepared in the device; typically, for constant cooling power, the higher the flow rate is (the temperature of the fluid introduced remaining the same, that of ambient) the higher the temperature of the dispensed product is, as the less the residence time of the product in the processing chamber is).

In the case of preparing a cooled or chilled liquid, no air is introduced together with the fluid through the product inlet 20 and the foaming element 100 rotates at low speed, typically comprised in the range of 1 rpm to 10 rpm, allowing that the fluid is homogeneously mixed and cooled. Thanks to the heat exchange in the processing chamber 108, the refrigerating surface 104 is cooling down the fluid to a final temperature comprised between 5° C. and 0° C. before it is delivered through the product outlet 30. The scraping element 200 helps to take off the product on the inner walls of the refrigerating surface 104 into the whole fluid mixture, so as to homogenously distribute cold within it.

In the case of preparing a foamed product (that can be chilled or not), air is introduced together with the fluid through the product inlet 20 and the foaming element 100 rotates at a high speed, typically comprised between 1000 rpm and 3000 rpm. When cooled or chilled product is desired, the evaporator 60 acts on the temperature of the refrigerating surface 104 to cool the foamed fluid to a temperature typically comprised between 5° C. and 0° C. before it is delivered through the product outlet 30. The high speed of the foaming element 100 is intended to properly mix and foam the fluid mixture, helping to break fluid bubbles and incorporate air in the mixture, aerating it.

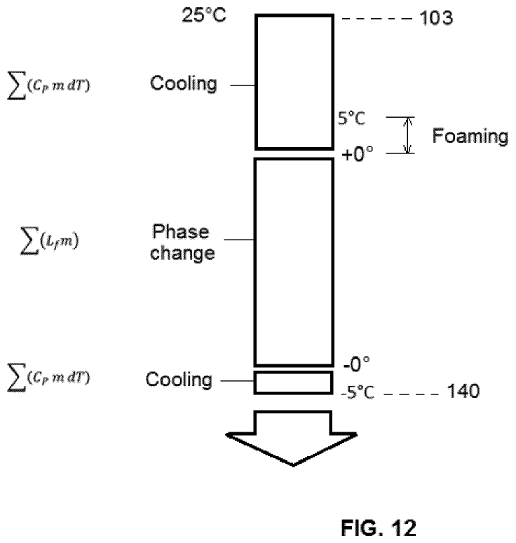

When preparing ice-cream with the device of the invention, air is introduced together with the fluid through the product inlet 20 and the foaming element 100 typically rotates at high speed, comprised between 1000 rpm and 3000 rpm. The evaporator 60 acts on the temperature of the refrigerating surface 104 to cool the foamed fluid to a temperature typically of −0° C. (see FIG. 12) to −5° C. to −10° C. before it is delivered through the product outlet 30. The scraping element 200 needs to scrap the frozen mixture adhering to the inner walls of the refrigerating surface 104 so as to incorporate it to the mixture in order to produce the ice-cream. Further, the mixture is aerated thanks to the high rotational speed of the foaming element 100.

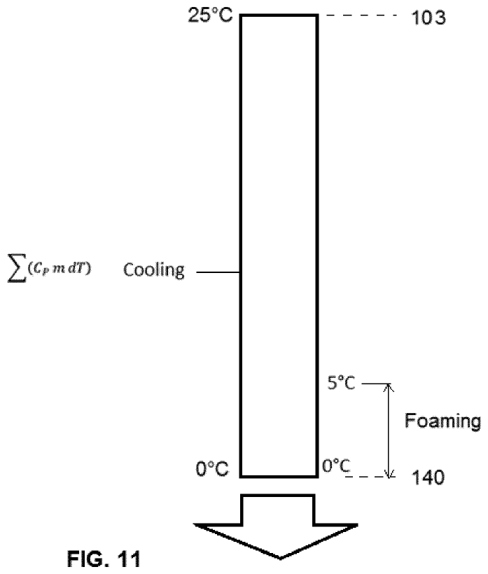

Referring now to FIG. 11, the theoretical energy path followed in a device according to the invention for a cooled aerated product is schematically represented, from one end of the processing chamber 108 (connecting with the product inlet 20) to the other end of the processing chamber 108 connecting with the product outlet 30. The fluid enters the processing chamber at ambient temperature, typically comprised between 20° C. and 25° C., is then cooled by contacting the refrigerating surface 104 and then distributed into the mixture thanks to the rotation of the foaming element 100 and of the scraping element 200. Effective foaming of the mixture of fluid and air (when air enters the product entry 20 together with the fluid) occurs at temperature comprised between 5° C. and 0° C., as shown in the graph of FIG. 11.

The energy balance, i.e. heat energy related to temperature difference for the fluid inside the processing chamber is given by:

Σ(Cₚm dT)
where:
Cₚ is the specific heat capacity depending on the material
m is the mass of the product or ingredient
and
dT is the temperature difference (dT=T_{final}−Tᵢₙᵢₜᵢₐₗ)

The formula above gives heat energy transfer linked to the change of temperature of the product inside the processing chamber from ambient temperature into a lower temperature T₁ at the product outlet beverage outlet, typically comprised between 0° C. and 5° C.

Referring now to FIG. 12, the theoretical energy path followed in a device according to the invention for a frozen aerated product produced is schematically represented, from one end of the processing chamber 108 (connecting with the product inlet 20) to the other end of the processing chamber 108 connecting with the product outlet 30. The fluid enters the processing chamber at ambient temperature, typically comprised between 20° C. and 25° C., and is then cooled down to a temperature of +0° C. in approximately 30% to 35% of the path of the processing chamber (in fact, efficient foaming takes place typically from 5° C. to +0° C., in approximately 5% to 10% of the path, as represented in FIG. 12). The energy balance, i.e. the heat energy related to the change of temperature of the product inside the processing chamber from ambient temperature into a lower temperature T₁ (+0° C.) after travelling a 30% to 35% of the total path of the processing chamber is given by:

Σ(Cₚm dT)
where:
Cₚ is the specific heat capacity depending on the material
m is the mass of the product or ingredient
and
dT is the temperature difference (dT=T_{final}−Tᵢₙᵢₜᵢₐₗ)

Then, the product changes phase from liquid into solid, maintaining its temperature at around 0° C. (in fact, changing from +0° C. to −0° C.): it is estimated, as represented in FIG. 12, that approximately 50% of the total mass of the product changes phase into solid and approximately 50% to 60% of the total path of the processing chamber has been travelled.

The heat energy related to this phase change is give by:

Σ(L_{f}m)
where:
Lf is the latent heat depending on the material
and
m is the mass of the product or ingredient

Finally, the rest of 5% to 10% of the path of the processing chamber travelled by the product makes the product reduce its temperature further, from −0° C. to approximately −5° C., until it is delivered as ice-cream product through the product outlet 30. The energy balance, i.e. heat energy related to temperature difference for the fluid inside this path of the processing chamber is given by:

Σ(Cₚm dT)
where:
Cₚ is the specific heat capacity depending on the material
m is the mass of the product or ingredient
and
dT is the temperature difference (dT=T_{final}−Tᵢₙᵢₜᵢₐₗ)

The formula above gives heat energy transfer linked to the change of temperature of the product inside the processing chamber from −0° C. to −5° C., which is the final delivery temperature of the frozen product. Effective foaming of the mixture of fluid and air (when air is introduced together with the fluid through the product inlet 20) occurs at temperature comprised between 5° C. and +0° C., as shown in the graph of FIG. 12.

All what has been described above is also valid for a device 10 according to a second embodiment of the invention, where the foaming element and the scraping element are configured as one single element, in what will be referred to as foaming and scraping element 300 (as represented in FIGS. 7-9).

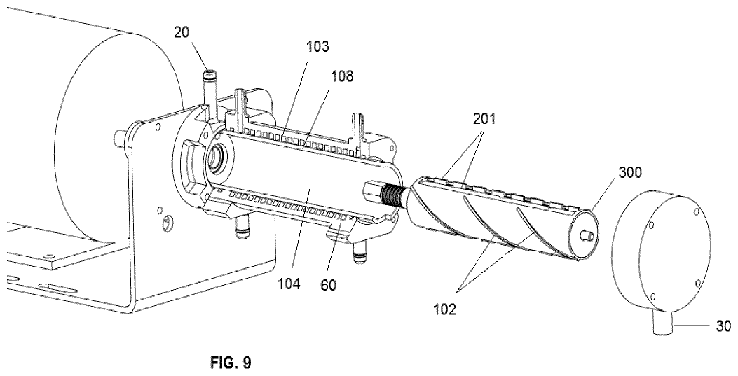

As shown in FIGS. 7-9, representing a second embodiment of the device 10 of the present invention, in this embodiment both the foaming and the scraping elements are configured in one single element, so called foaming and scraping element 300 (see for example FIG. 9). Preferably, this element 300 is configured having the shape of a cylinder, and typically comprises disturbing elements or a foaming embossing 102 arranged external to it, in order to help the foaming of the mixture of fluid and air coming from the product inlet 20. Furthermore, the foaming and scraping element 300 is provided with one or more scraping components, typically scrapers 201. These scrapers are typically mounted on an elastic element (typically a spring or the like) which allows a perfect contact of these scrapers with the internal walls of the refrigerating surface 104 that have to be scraped.

Preferably, the disturbing elements or foaming embossing 102 are arranged outside the surface of the foaming and scraping element 300 under a helicoidal shape allowing to direct the flow of fluid towards the exit of the product, i.e. towards the product outlet 30.

With the described configuration, the element 300 is configured to be able to move (rotate) within the processing chamber 108 and foam (by means of the foaming embossing 102) and scrap (by means of the scrapers 201) at the same time.

For this second embodiment of the invention, it is evident that only one motor is needed, a foaming and scraping motor 73, as represented in FIG. 9, for example. This single motor is able to rotate the element 300, whose rotation will provide both the foaming and the scraping of the product within the processing chamber 108.

One or two (or even more) refrigerant inlets (40, 40′) or refrigerant outlets (50, 50′) are possible in different configurations of the device 10 according to the present invention.

The main principle followed by a device according to the present invention (for any of the two possible embodiments) is that, departing from the quantity of product desired to be prepared, it is therefore known the total heat energy balance needed to change this fluid product at ambient temperature of depart into another product (cooled only or frozen, with the possibility of further being foamed). Further, the power of the evaporator 60 doing the cooling is known and so is the total volume of the path that the fluid will follow: thus, it is in this volume (during a certain residence time) that the product needs to pass through a certain energy transfer in order to achieve the desired cooling and possible phase change. The energy removal is provided by the evaporator 60.

Therefore, for a certain product to be achieved (frozen or chilled liquid), departing from known information (type of product and the power the evaporator 60 can provide) what is adjusted in the device of the invention is the flow rate of the product through the processing chamber 108, i.e. the residence time of the product passing into the processing chamber: departing from a known product at certain conditions, this residence time in the processing chamber 108 must provide the final product desired. Other characteristics of the final product will be given by the rotational speed of the foaming element 100 and of the scraping element 200 (or the rotational speed of the foaming and scraping element 300): higher speed for ice-cream and foamed products and lower speed for cooled or chilled liquids, and also by the air ratio introduced together with the fluid into the processing chamber (through the product inlet 20).

Typically, the device of the invention works inline and provides a certain desired amount of fluid into final product as a frozen, chilled and possibly foamed product delivered through the product outlet 30.

As already described, the fluid entering the device 10 through the product entry 20 can come from external containing means (not shown) or it can come for example from a capsule or confined container which is externally plugged to the device 10. In this last case (capsule-type container), the container will preferably comprise identification means with the information on the parameters to be used to prepare a cooled or frozen and possibly further aerated product, such as type of product to be produced in the device, temperature of the product to be delivered, processing time in the device, rotational speed of the processing element (foaming, scraping element) of the device, amongst others. Typically, the device will be therefore provided with a processor configured to read the information on the identification means and execute the required parameters during the product preparation process.

Even when all the Figures attached represent the device 10 (in both first and second embodiments) in horizontal arrangement, the device can either work in a horizontal or in a vertical position.

According to a second aspect, the invention further relates to a method for preparing a cooled or frozen product, which can also be aerated, in a device as the one described above. The method of the invention comprises:
Delivering a fluid through the product inlet 20 into the processing chamber 108 of the device 10, the fluid being delivered at a certain flow rate;
Depending on the type of product to be made (aerated or not), possibly adding air also in the fluid delivered through the product inlet 20;
Depending on the type of product to be made, rotating at a certain speed the processing element (by processing element it is to be understood either the foaming and scraping element 300 configured as one element, according to a second embodiment of the invention; or the foaming element 100 and the scraping element 200, configured as two distinct elements, according to a first embodiment of the device of the invention);
Simultaneously to the rotation of the processing element, the evaporator 60 is activated so the refrigerating surface 104 is refrigerated, thus cooling down the product contacting it inside the processing chamber 108.

Although the present invention has been described with reference to preferred embodiments thereof, many modifications and alterations may be made by a person having ordinary skill in the art without departing from the scope of this invention which is defined by the appended claims.

1. Device for preparing a cooled or frozen and/or foamed product, comprising:
a product inlet through which a certain quantity of fluid at ambient temperature, enters the device, at a certain flow rate, this flow rate depending on the type of product to be prepared by the device;
a processing chamber through which the fluid flows and where it is processed, the processing chamber defining a volume for the flow of fluid;
at least a processing element rotatable within the processing chamber and configured to mix and/or scrap and/or foam by Couette Flow effect the fluid flowing through it; and
a cooling element providing a certain cooling power configured to cool at least partially the processing chamber which is at least partially in contact with the fluid.

2. Device according to claim 1 wherein the processing element comprises a single rotatable element, this single rotatable element comprising at least one of disturbing members allowing foaming of the fluid in the processing chamber when the element rotates, the element further comprising at least one scraper allowing scraping of the product from the walls of the processing chamber when the element rotates.

3. Device according to claim 2 wherein the scraper is mounted on an elastic member allowing them to properly contact the inner walls of the processing chamber.

4. Device according to claim 1 wherein the rotational speed of the processing element is calculated as a function of the type product to be prepared in the device and/or its foaming level.

5. Device according to claim 1 wherein the processing element comprises a foaming element and a distinct scraping element, both elements being rotatable in the processing chamber at the same or different speed and/or direction of rotation.

6. Device according to claim 5 wherein the rotational speed and/or the direction of rotation of the foaming element and of the scraping element are calculated depending on the type of product to be prepared in the device and/or on its foaming level.

7. Device according to claim 1 wherein the flow rate of fluid into the processing chamber is calculated to allow that the cooling power provided by the cooling element cools the fluid to a desired temperature before the fluid leaves the processing chamber.

8. Device according to claim 1 wherein the rotational speed of the processing element is in the range of 1 to 10 rpm to prepare a cooled or chilled product.

9. Device according to claim 1 wherein the rotational speed of the processing element is in the range of 1000 to 3000 rpm to prepare an ice-cream product or a foamed or aerated product.

10. Device according to claim 1 wherein the processing chamber connects the product inlet and a product outlet, so that the cooled or frozen and/or foamed product is delivered continuously.

11. Device according to claim 1 wherein the length of the processing chamber traversed by the fluid matches the cooling element, defining an inner refrigerating surface in contact with the fluid flow.

12. Device according to claim 1 wherein the processing element is configured as a cylinder, rotating inside a cylindrical processing chamber, concentrically arranged within it and forming a gap of a thickness between them through which the fluid flows and is processed.

13. Device according to claim 12 wherein the gap configured between the cylinders has a thickness of between 0.1 mm and 10 mm.

14. Device according to claim 1 being connectable to a container configured as a cartridge, as a capsule or the like, where a fluid at ambient temperature is stored to be provided in the device through the product inlet.

15. Device according to claim 14, connectable to a container comprising identification means, the identification means comprising process parameters allowing the preparation of a cooled or frozen and/or foamed product in the said device.

16. Device according to claim 15 wherein the process parameters are selected from the group consisting of: type of product to be produced, temperature of the product delivered, flow rate of fluid in the processing chamber, rotational speed of the processing element, and air ratio to incorporate in the processing chamber.

17. Device according to claim 1, the device being configured to be arranged either horizontally or vertically when it is in operation.

18. Method for preparing a cooled or frozen and/or foamed product using a device comprising: a product inlet through which a certain quantity of fluid at ambient temperature, enters the device, at a certain flow rate, this flow rate depending on the type of product to be prepared by the device; a processing chamber through which the fluid flows and where it is processed, the processing chamber defining a volume for the flow of fluid; at least a processing element rotatable within the processing chamber and configured to mix and/or scrap and/or foam by Couette Flow effect the fluid flowing through it; and a cooling element providing a certain cooling power configured to cool at least partially the processing chamber which is at least partially in contact with the fluid, the method comprising:
delivering a fluid through the product inlet into the processing chamber of the device at a certain flow rate defined so as to provide the fluid with a certain residence time in the device, before it is delivered through a product outlet;
depending on the type of product to be made, rotating at a certain speed the processing element; and
simultaneously to the rotation of the processing element, activating the cooling element to cool at least partly the processing chamber in contact with the fluid.

19. Method according to claim 18 wherein the rotational speed and/or the direction of rotation of the processing element varies depending on the product to be prepared, from a low speed in the range of 1 to 10 rpm to prepare a cooled or chilled product to a high speed in the range of 1000 to 3000 rpm to prepare an ice-cream product or a foamed or aerated product.

20. Method according to claim 18 wherein air is introduced into the processing chamber when aerated product is desired.

21. (canceled)
